(19) United States
(12) Patent Application Publication
(10) Pub. No.: US 2007/0251799 A1
(43) Pub. Date: Nov. 1, 2007

(54) TOKEN SELECTING DEVICE IN A TOKEN INPUT DEVICE OF A GAME MACHINE

(76) Inventors: Hiroshi ABE, Saitama-shi (JP); Nobuo Yano, Saitama-shi (JP); Hiroshi Ohtomo, Saitama-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 11/551,837

(22) Filed: Oct. 23, 2006

(30) Foreign Application Priority Data
Oct. 24, 2005 (JP) JP 2005-308760
Sep. 19, 2006 (JP) JP 2006-253406

(51) Int. Cl. G07F 7/00

(52) U.S. Cl. 194/209

(57) ABSTRACT

A token input device of a game machine is provided in which a token input from an input port is allowed to roll on a rolling rail and drop on a predetermine position of a game machine. A selecting device of the token is disposed in the midst of the rolling rail, wherein the selecting device includes at least a material sensor of the token. A canceling device removes the rolling token from the rolling rail based on the signal from the material sensor. The canceling device is disposed downstream of the material sensor.

### CROSS REFERENCE TO RELATED APPLICATIONS

This application claims the benefit of priority under 35 U.S.C. § 119 of Japan Patent Application JP 2005-308760 filed Oct. 24, 2005 and Japan Patent Application JP 2006-253406 filed Sep. 19, 2006, the entire contents of each of which are incorporated herein by reference.

### FIELD OF THE INVENTION

The present invention relates to a token selecting device in a token input device that inputs a token into a game machine and more particularly to a token selecting device in an input device capable of selecting tokens of different materials in addition to the diameter and thickness of the token. Further, the present invention relates to a token selecting device easily capable of setting the selection reference of the tokens to be selected. In this text the term token refers for example to coins, tokens, disks, medals or similar disk type media.

### BACKGROUND OF THE INVENTION

As a conventional technology, a token selecting mechanism in the token input device of a game machine is known from Japanese Patent Application Laid-Open No. 11-76598 (FIGS. 1 to 3, Pages 2 to 4), in which a token less than a predetermined thickness is permitted to pass through the bottom in the midst of a token guide passage of the token that allows the token to move while rolling. A token selecting hole that prevents passage of the token equal to or more than a predetermined thickness is provided. Moreover, a small diameter token removing means is provided that removes the token of less than the predetermined diameter to the lateral side of the guide passage.

In the selecting device of the token input device of the conventional technology, the tokens that are input that are below the standard of the diameter and thickness of the token are sometimes cancelled. However, there is the possibility that tokens of the same diameter and thickness, but consisting of a different material, are input and accepted. In other words, there is a problem that the tokens of another game hall are mixed in. Since the tokens are purchased by a customer in exchange for money, when the tokens of another game hall are used, it means that the game is played free of charge.

Consequently, the mixture of the tokens of another gaming hall is conducive to using the tokens of another gaming hall by the customer. This then requires removing operations for removing the tokens of another gaming hall from all the tokens after the close of a business day. This causes a problem requiring a great deal of labor and time.

### SUMMARY OF THE INVENTION

A first object of the present invention is to provide a token selecting device capable of at least canceling tokens that are made of a different material from that intended to be used in the token input device of the game machine.

A second object of the present invention is to provide a small-sized token selecting device installable on the token input device of the game machine.

A third object of the present invention is to provide a token selecting device capable of easily changing the setting of the tokens to be selected in the token input device of the game machine.

To achieve these objects, according to the invention, a token input device of a game machine is provided in which the token input from the input port is allowed to roll on the rolling rail and drop on the predetermined position of the game machine. A token selecting device is disposed in the midst of the rolling rail. The selecting device at least includes a token material sensor and a canceling device that removes the token from the rolling rail that has been rolled, based on a signal from the material sensor. The canceling device is provided downstream of the material sensor.

In this configuration, the token, during the course of rolling on the rolling rail, is detected at least by the material sensor. Based on the signal from the material sensor, the authenticity of the token is discriminated. Based on this discrimination result, the canceling device, positioned downstream of the material sensor, is operated and the token is removed from the rolling rail and rejected. Consequently, the tokens of another gaming hall that are different in material are not input into the game machine and the tokens different in material can be collected at one place. This presents the advantage that classifying and processing of the tokens of another gaming hall can be easily performed.

The token selecting device in the input device of the game machine may include a diameter coil type magnetic sensor that obtains data regarding the diameter of the token. This may be disposed adjacent to the token rolling passage. This is located at a predetermined distance from the rolling rail. A material coil type magnetic sensor may be provided that obtains data regarding the material and thickness of the token, with it disposed adjacent to the token rolling passage closer to the rolling rail than the diameter coil type magnetic sensor. A thickness coil type magnetic sensor may be provided that obtains data regarding the thickness of the token. In this configuration, the selecting device includes a diameter sensor and material sensor and thickness sensor configured by a coil type magnetic sensor. Consequently, the input token is discriminated as to whether the token is true or not, by material, diameter, and thickness, and therefore, there is the advantage that the selecting accuracy as to another gaming hall token is high. Further, the data regarding the material and thickness of the token is detected by one common thickness coil type magnetic sensor. Consequently, while the sensor is usually used for individual purposes, the data regarding two tokens can be obtained by one sensor, and therefore, there is the advantage that the selecting device can be reduced in size. Further, the material magnetic sensor and the thickness magnetic sensor are disposed at the position closer to the rolling rail than the diameter sensor, and therefore, can be disposed to be overlapped in the extending direction of the rolling rail, and there is the advantage that the total length thereof can be made short.

The token selecting device in the input device of the game machine may be such that the material coil type magnetic sensor and thickness coil type magnetic sensor include central cylinders in the center, and include external walls at the outside of the central cylinders, and ring shaped thickness coils are disposed at the outside of the central cylinders of pot type cores by which bottom wall these central cylinders and the external walls are connected, and ring type material coils are disposed at the outside of the thickness coils. In this configuration, the material and thickness sensors are disposed in the common pot core, and therefore, there is the advantage that the selecting device can be made small in size.

The token selecting device in the input device of the game machine may be provided with the canceling device including a canceler pivotally attached to a pivot axis disposed in parallel with the token rolling passage at the lateral side of the token rolling passage. The canceler may have a free end positioned at the opposite side of the pivot axis reciprocated in the rolling passage. In this configuration, the canceler performs a pivot movement for the rolling passage of the token with the pivot axis of the upper stream side as a point of support, and the top end portion thereof protrudes from the cross sectional direction toward the rolling passage. Consequently, the canceler is obliquely positioned for the rolling passage, and therefore, the token is gradually deviated from the rolling rail, and therefore, there is the advantage that the tokens continuously rolled can be surely cancelled.

The canceling device may include a movable guide that guides an upper end side surface of the token rolling at the opposite side of the canceler for the rolling rail. In this configuration, the upper end portion of the token rolling on the rolling rail in opposite to the canceler is guided by the movable guide. Consequently, when the canceler is protruded to the rolling passage and forcibly pushed, the token deviates from the rolling rail and dropped. However, for example, when the rolling rail is slightly moved left and right, the top end portion of the token is held by a side surface guide, and therefore it is not dropped from the rolling rail. Consequently, even when the customer slightly moves the rolling rail left and right e.g., for purposes related to a game skill, a true token can reach a dropping port without dropping from the rolling rail and therefore. This presents the advantage that the token is dropped when it is forcibly deviated by the canceler in the cross sectional direction. Further, when the token is pushed in the cross sectional direction by the canceler, though there is the possibility that the token is flicked out, the upper end portion of the token is restrained from moving by the movable guide. Hence, the token is not flicked out, and the dropping position becomes approximately constant.

The movable guide may be elastically biased to the token rolling passage. In this configuration, when the false token is abruptly pushed by the canceler, the movable guide is suddenly moved against the elastic force by the upper end portion of the false token. As a result, the false token deviates from the rolling rail, and can drop. In this case, the movable guide is elastically moved, and the movement is reduced in force, and therefore, the token drops approximately downward. In other words, there is the advantage that the tokens from the small diameter to the large diameter can use the same selecting machine.

A token timing sensor may be disposed between the material sensor and the canceler device. A control device that operates the canceler device is provided based on false and true signals from the material sensor and the detection of the timing sensor. In this configuration, when the token is cancelled by the canceler, a cancel operation is performed based on the detection signal of the token from the timing sensor disposed in the downstream of the material sensor. Consequently, a distance between the timing sensor and the canceler is constant, and since the token moves at a constant speed, the token is in opposed relationship to the canceler or before being in an opposition to the canceler, the canceler can be activated to protrude into the rolling passage. Hence, there is the advantage that the token that must be cancelled and can be surely dropped from the rolling rail by the canceler.

According to another aspect of the invention a token selecting device is provided in a token input device of a game machine. The token selecting device includes a canceler device that allows a token input from an input port to roll on a rolling rail and drop on a predetermined position of the game machine. The token selecting device includes at least a token material sensor in the midst of the rolling rail, and also provides a canceler device that removes the rolling token from the rolling rail based on a signal from the material sensor. The token selecting device also includes a selection reference value obtaining mode setting means; a storing means that stores a token signal from the sensor device at the selection reference value obtaining mode time; a calculating means that calculates the reference value based on the data stored in the storing means; and a means that sets the reference value based on the calculation result of the calculating means. In this configuration, the selecting device is set to the selection reference value obtaining mode by the mode setting means, and moreover, when a true token is input, the signal at least from the material sensor is stored. The data that is obtained from and stored from the material sensor(s) is processed for the preparation of the reference value by calculating means. This prepared reference value is set to the reference value by setting means. In other words, when the material and the like of the token used by the customer is changed, there is the advantage that new tokens are input into the token input device for the predetermined number of pieces, so that the reference value that selects the token can be prepared.

According to this further aspect of the invention, the selecting device may include at least one magnetic sensor for sensing the diameter, material or thickness of the token. The magnetic sensor may have a central cylinder at the center and an external wall at the outside of the central cylinder and comprise a pair of sensor units. The units may have a ring shaped coil disposed at the outside of the central cylinder of a pot shaped core, by which bottom wall, the central cylinder and the external wall are connected. The pair of sensor units are installed in a first main body and a second main body, respectively, which are disposed at a predetermined interval. This presents a sandwiching of the rolling rail in the selecting device. The rolling rail is configured by inclined planes protruding downward to mutually approach from the first main body and second main body. The canceling device is provided to remove the rolling token based on the signal from the magnetic sensor from the rolling rail and is disposed downstream of the magnetic sensor.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a token input device of a game machine installed with a selecting device of a first embodiment of the present invention;

FIG. 2 is a front side broken away view of the token selecting device in an input device in the game machine of the first embodiment of the present invention;

FIG. 3 is a rear side view of the token selecting device in an input device in the game machine of the first embodiment of the present invention;

FIG. 4 is an enlarged perspective view of the token selecting device in an input device in the game machine of the first embodiment of the present invention;

FIG. 5A is a cross-sectional view cut along the line A-A of FIG. 2 of the selecting device of a token input device in the game machine of the first embodiment of the present invention;

FIG. 5B is a cross-sectional view cut along the line B-B of FIG. 2 of the selecting device of a token input device in the game machine of the first embodiment of the present invention;

FIG. 5C is a cross-sectional view cut along the line C-C of FIG. 2 of the selecting device of a token input device in the game machine of the first embodiment of the present invention;

FIG. 6 is an enlarged perspective view of the canceler and a driving system of the token selecting device in an input device of the game machine of the first embodiment of the present invention;

FIG. 7 is a discrimination block diagram of the token selecting device in an input device in the game machine of the first embodiment of the present invention;

FIG. 8 is a block diagram of a reference value setting device of the token selecting device in an input device in the game machine of the first embodiment of the present invention;

FIG. 9A is an operation explanatory drawing of the token selecting device in an input device in the game machine of the first embodiment of the present invention;

FIG. 9B is another operation explanatory drawing of the token selecting device in an input device in the game machine of the first embodiment of the present invention;

FIG. 10A is a graph for an actuation explanatory of the token selecting device in an input device in the game machine of the first embodiment of the present invention;

FIG. 10B is a graph for an actuation explanatory of the token selecting device in an input device in the game machine of the first embodiment of the present invention; and

FIG. 11 is a cross-sectional view of the second embodiment equivalent to FIGS. 5A-C in the first embodiment.

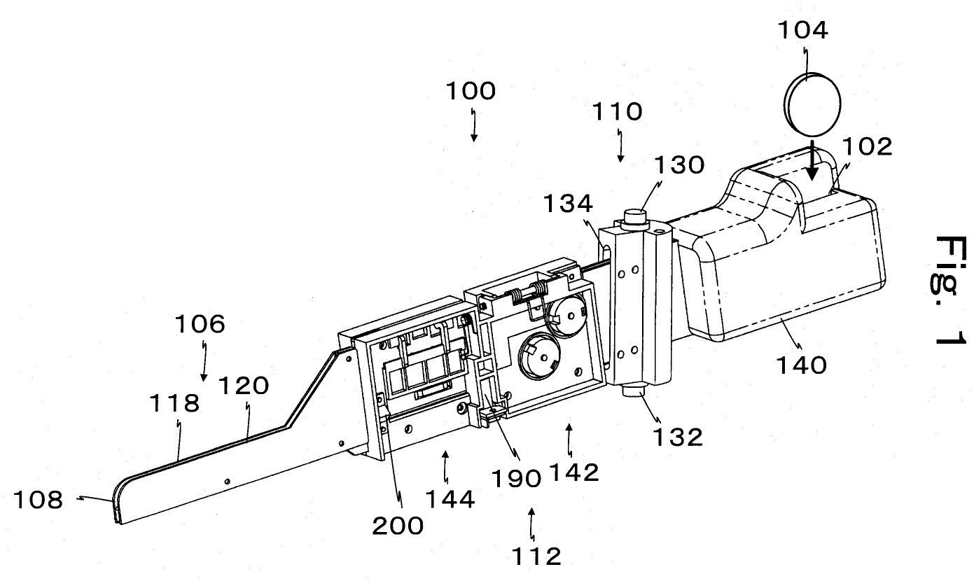

### DESCRIPTION OF THE PREFERRED EMBODIMENTS

Referring to the drawings in particular, a token input device generally designated 100 of a game machine allows a token 104 input from an input port 102 to roll on a rolling rail 106 and drop on a predetermined position of the game machine. The invention comprises such a token input device 100 with a token selecting device in the midst of the rolling rail 106. The token input device 100 of a game machine has the functions of allowing a game token 104 input to an input port 102 to roll along a rolling rail 106 and drop from a throw-out port 108, and at the same time, cancelling a false rolling token on a rolling rail 106. The token input device 100 approximately includes the rolling rail 106, a pivot bearing 110 of the rolling rail 106, the token input port 102, a selecting device 112 of the token, and a throw-out port 108.

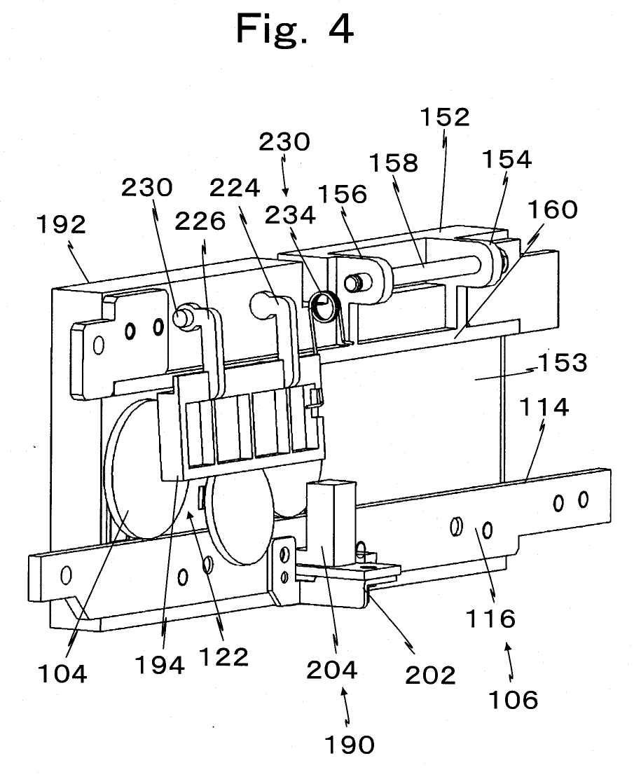

The rolling rail 106 has the functions of allowing the token 104 input from the input port 102 to roll and guiding it to the throw-out port 108. The rolling rail 106 has a slightly wider thickness than the thickness of the token 104 to be input, and moreover, includes a linear guide rail 116 (FIG. 4) which is a rolling surface 114 with its upper surface elongated. A tabular left guide plate 118 and a right guide plate 120 are fixed to both sides of this guide rail 116. The rolling rail 106 is fixed to the pivot bearing 110 at a predetermined angle with its front slanting downward. The downward slant provides a state in which the throw-out port 108 is considerably downward with respect to the input port 102. Consequently, the token 104 rolls on a rolling passage 122, which is elongated and narrow in width and surrounded by the rolling surface 114 of the guide rail 116, the left guide plate 118, and the right guide plate 120.

The pivot bearing 110 holds the rolling rail 106 at a predetermined angle, and at the same time, supports it pivotally around an axis line within a range of small angles. The pivot bearing 110 has a shaft shape approximately extending vertically. Support axes 130 and 132, protruding upward and downward from the bearing, are pivotally supported by a frame body (not shown) of the game machine within a range of small angles. A through hole 134 is bored across the axle center of the pivot axis of the pivot bearing 110. The rolling rail 106 is inserted into the through hole 134, and its median is fixed to the pivot axis of the pivot bearing 110. Consequently, the rolling rail 106 is pivotable within a range of the predetermined small angles left and right around the support axes 130 and 132. This pivotal movement of small angles is used for the customer to control timing by which the token 104 drops from the input device 100. In other words, the rolling rail 106 is pivotable left and right increment by increment, and as a result, the token 104 rolling on the rolling surface 114 is brought into contact with the left guide plate 118 and the right guide plate 120 so as to be given a braking force. By adjusting the rolling speed of the token 104, the dropping timing from the throw-out port 108 can be controlled.

The input port 102 has the function of guiding the token 104 input by the customer on the rolling rail 106. The input port 102 has a size slightly larger than the maximum diameter and maximum thickness of the usable token 104, and comprises an upward rectangle opening which is formed in the end portion of a cover 140 molded by resin. Consequently, the input port 102 has the functions of preventing a false token of the diameter larger and a false token thicker than the predetermined value from being input. The cover 140 is fixed to the end portion positioned outside of the game machine of the rolling rail 106.

The throw-out port 108 is an end portion positioned inside the game machine of the rolling rail 106, and is an exit of the rolling passage 122 of the token 104.

The selecting device 112 has the functions of discriminating the authenticity of the token 104 that is input into the input port 102, and that rolls on the rolling passage 122. The selecting device 112 allows the token 104 to be removed from rolling passage 122 and not to be dropped from the throw-out port 108 when it is a false token. The selecting device 112 includes a sensor device 142 and a canceling device 144.

The sensor device 142 will be described according to the first embodiment of the invention. The sensor device 142 has the functions of obtaining the data to discriminate the authenticity of the token 104 rolling on the rolling passage 122. In the present embodiment, the sensor device 142 includes a diameter sensor 146, a thickness sensor 148, a material sensor 150, a first main body 152 and a second main body 154. The diameter sensor 146, thickness sensor 148 and material sensor 150 are preferably coil type magnetic sensors. This is because these sensors can be configured by a ferrite core and a coil, and are moderate in price.

The first main body 152 and the second main body 154 are fabricated by injection molding by non-magnetic material, for example, resin. The first main boy 152 is approximately rectangular and has its end portion fixed to the guide rail 116 downstream of the pivot bearing 110. Sidewise bearings 154 and 156 protrude on the upper portion of the first main body 152 at a predetermined space. A sensor support axis 158 is attached in parallel with the guide rail 116.

The side surface 153 of the rolling passage 122 side of the first main body 152 is a flat surface, and a rib-shaped spacer protrusion 160 is protruded upward slightly away from the rolling surface 114 than the diameter of the maximum token. In other words, the spacer protrusion 160 is positioned in parallel with the guide rail 116 slightly spaced away from the diameter of the maximum token, and the distance it protrudes is the same as the thickness of the guide rail 116.

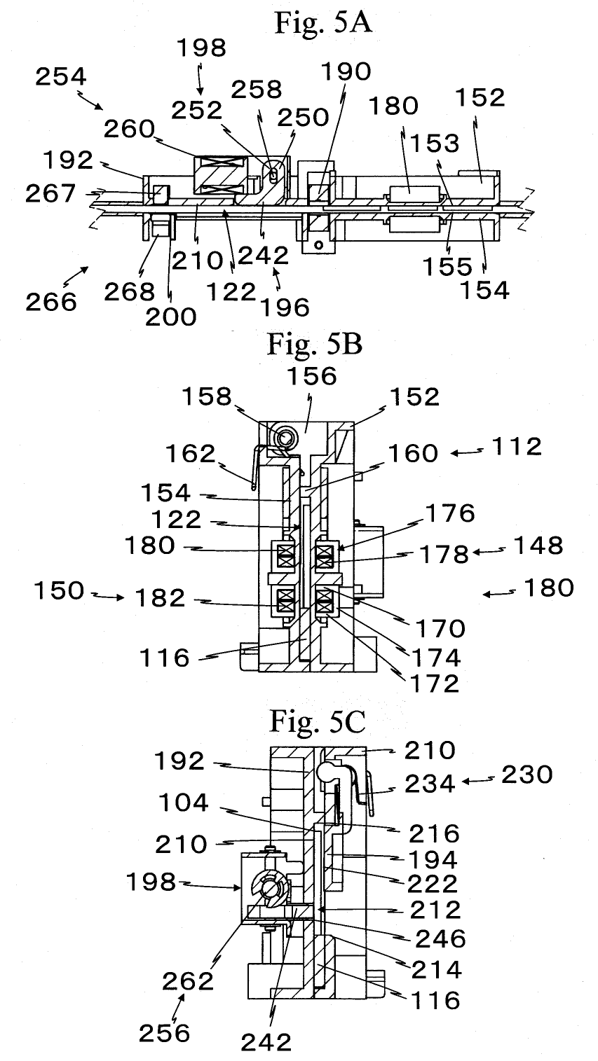

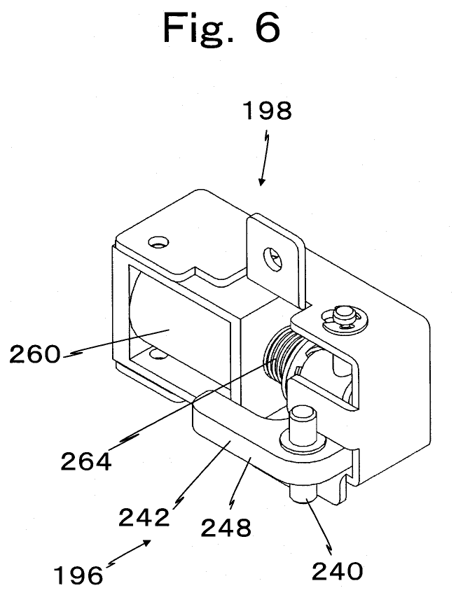

The second main body 154 is formed rectangular in the same size as the first main body 152, and its upper end portion is pivotally supported by the sensor support axis 158. The side surface 155 of the rolling passage 122 is flat. Further, the second main body 154 has its median wound around by the sensor support axis 158, and its one end fitted to the inner side upper end portion of the second main body 154, and moreover, the other end given a counter-clock wise moment (FIG. 5B) by a spring 162 fitted to the outer side upper end portion. Consequently, by the thickness of the spacer protrusion 160 and the guide rail 116, the space between the first main body 152 and the second main body 154 is controlled. By this configuration, the rolling passage 122 of the token 104 in the sensor device 142 is a flat space surrounded by the rolling surface 114, the side surface 153 of the first main body 152, the spacer protrusion 160, and the side surface 155 of the second main body 154. The second main body 154 is pivoted by a predetermined force, so that it is pivotable clockwise with the sensor support axis 158 as a point of support in FIG. 5B. When the second main body 154 is pivoted clockwise, a gap is formed between the second main body 154 and the guide rail 116, and therefore, the token 104 jammed in the rolling passage 122 can be removed from that gap.

The thickness sensor 148 has the functions of obtaining data regarding the thickness of the token 104. The material sensor 150 has the functions of obtaining data regarding the material of the token 104. The thickness sensor 148 and the material sensor 150 are a pair of magnetic sensors attached to the back surfaces of the first main body 152 and the second main body 154. The thickness sensor 148 includes a cylindrical central cylinder 170, a circular external wall 172 surrounding the outer periphery of the central cylinder 170 and a bottom portion 174 connecting the central cylinder 170 and the external wall 172. The thickness sensor 148 is configured by disposing a sensor unit 180 configured by a pot shaped core 176 made from a ferrite and a coil 178 wound around the central cylinder 170 in opposed relationship to the back surfaces of the first main body 152 and the second main body 154, respectively.

The material sensor 150 is configured by the core 176 and a coil 182 wound around the outside of the coil 178. The end surface of the core 176 is disposed close to the rolling surface 114 so that the entire surface faces the surface of the token of the minimum diameter assumed to be used. When the thickness sensor 148 and the material sensor 150 are configured by winding two coils 178 and 182 around one core 176 in this manner, there is the advantage that the sensor device 142 can be made relatively small as compared with the case where the core and coil are disposed individually. However, by winding the thickness sensor 148 and the material sensor 150 around a separate coil, each sensor can be disposed independently.

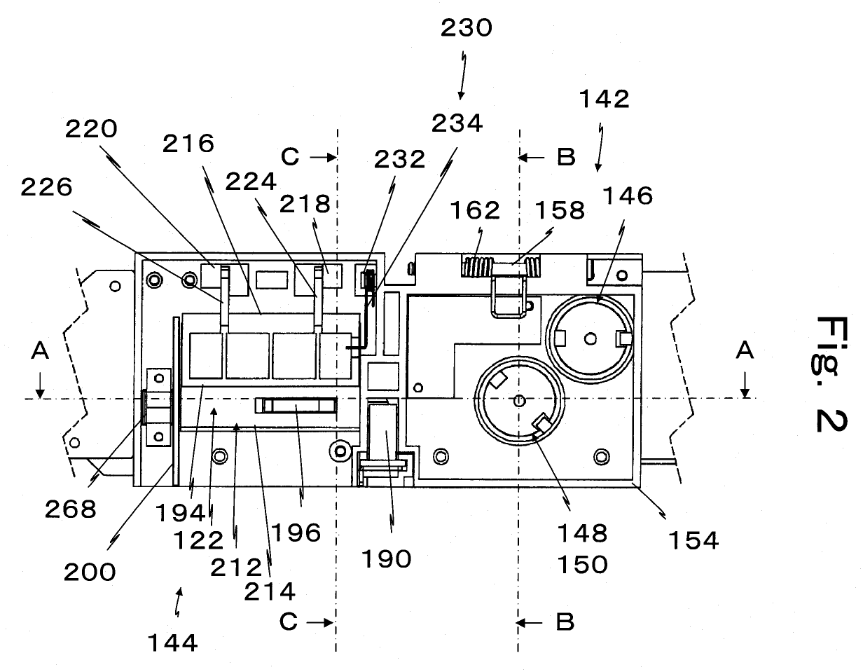

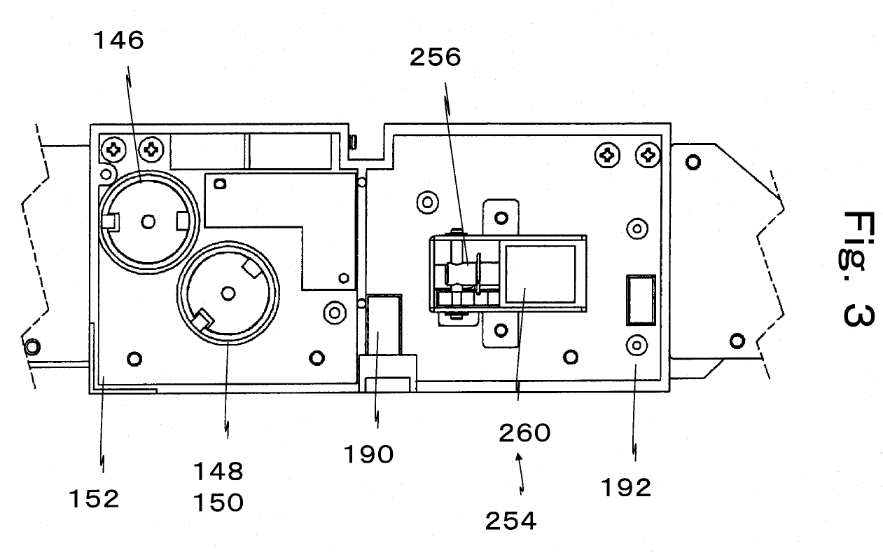

The diameter sensor 146 has the functions of obtaining the data regarding the diameter of the token 104 rolling on the rolling surface 114. The diameter sensor 146 is a coil type magnetic sensor configured by winding the coil around the central cylinder, the external wall, and the pot shaped core having a bottom portion connecting the cylinder and wall. The diameter sensor 146 is disposed at the upstream side of the rolling passage 122 closer to the input port 102 than the thickness sensor 148 and the material sensor 150, and is attached at the position far away from the guide rail 116. The diameter sensor 146 and the thickness sensor 148 and the material sensor 150, as shown in FIG. 2, are disposed overlapping slightly in the extending direction of the rolling passage 122. As a result, the length of the sensor device 142 can be made short.

The second main body 154 is disposed so as to be pivotable clockwise in FIG. 5(B) by the magnetic actuator (not shown) with the sensor support axis 158 as a point of support, so that the token 104 jammed in the sensor device 142 can be removed from the rolling passage 122.

The canceling device 144 has the functions of cancelling the false token 104 when a control device to be described later discriminates a token as a false token. The discrimination is based on a cancel signal output based on the data regarding the diameter, thickness, and material of the token 104 obtained from the sensor device 142. In other words, the canceling device 144 can remove the token 104 from the rolling passage 122. Particularly, the canceling device 144 has the functions of dropping the token 104 from the guide rail 116.

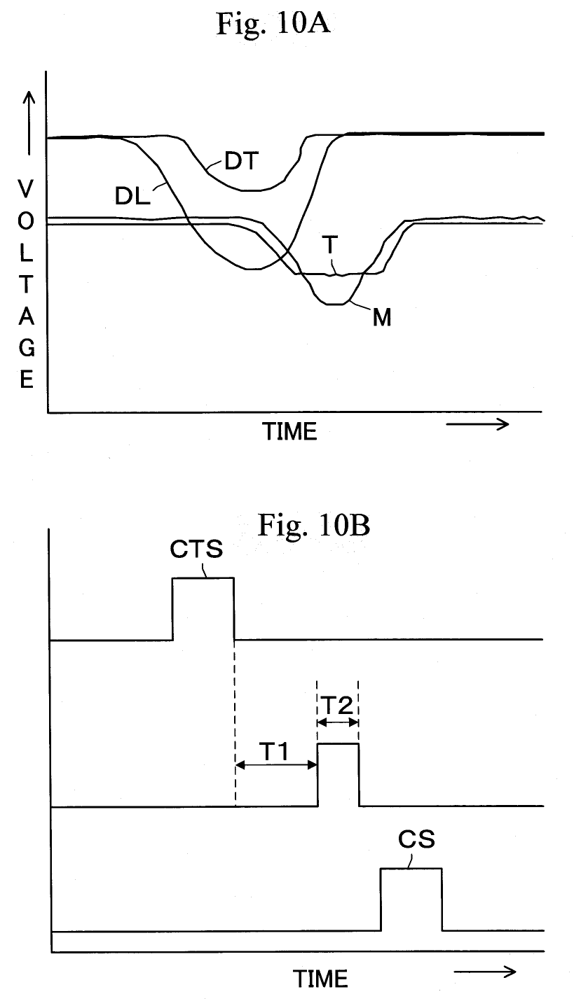

The canceling device 144 includes a timing sensor 190, a fixed main body 192, a movable guide 194, a canceler 196, a driving system 198, and a stopper 200. The timing sensor 190 has the functions of outputting an operation start timing signal CTS (FIG. 10(B)) of the driving system 198 of the canceler 196. The timing sensor 190 is disposed immediately downstream of the sensor device 142, and is fixed to the guide rail 116 through a bracket 202.

According to the first embodiment, the timing sensor 190 is a transmission type photoelectric sensor 204, which is opposedly disposed by sandwiching the rolling passage 122. An optical axis of the transmission type photoelectric sensor 204 is disposed close to the guide rail 116, and when the token 104 continuously rolls on, it is set to position in a triangle space 206 (FIG. 10B) formed within the peripheral surface of the token 104. Incidentally, in place of the timing sensor 190, the falling signal of the thickness sensor 148 or the material sensor 150 may be used. However, since the length from the canceler 196 is relatively long, the timing sensor 190 is preferable.

The fixed main body 192 has the function of defining one side surface of the rolling passage 122 and supporting the movable guide 194. The fixed main body 192 is in the shape of a rectangular plate, and is disposed integrally with the first main body 152 in the downstream side of the guide rail 116, and its lower end portion is fixed to the guide rail 116. The side surface 210 is in the shape of a flat plate, and defines one side surface of the rolling passage 122. The fixed main body 192 can be provided separately from the first main body 152.

The movable guide 194 has the function of guiding the upper end portion side surface of the token 104 rolling on the rolling passage 122, which is in opposed relationship to the canceling device 144. In opposed relationship to the fixed main body 194, and moreover, at the opposite side of the rolling passage 122, a rectangular ring-shaped movable guide frame 210 is disposed. The movable guide frame 210 is integrally provided with the second main body 154 in the present embodiment. In other words, the movable guide 194 is disposed immediately downstream of the second main body 154, and is biased in the direction of the fixed main body 192 by a spring 234. A lower edge 214 of the rectangular opening 212 of the frame 210 is positioned flush against or below the rolling surface 114, and an upper edge 216 is disposed in parallel with the rolling surface 114 slightly upper than the maximum token diameter. The upper portion of the frame 210 is provided with bearings 218 and 220 which protrude in the cross sectional direction at a predetermined space.

The movable guide 194 is a flat plate in the shape of a slender rectangle which extends approximately in parallel with the guide rail 116, and when a movable side surface 222 facing its side surface 210 is at a guide position which is in a normal state, it positions in parallel with the side surface 210, and defines the rolling passage 122. Support levers 224 and 226 extend upward from the upper portion of the movable guide 194, and the support axes 228 and 230 protruding in the cross-sectional direction from its upper end portion are provided. The support axes 228 and 230 are pivotally attached to the bearings 218 and 220, respectively.

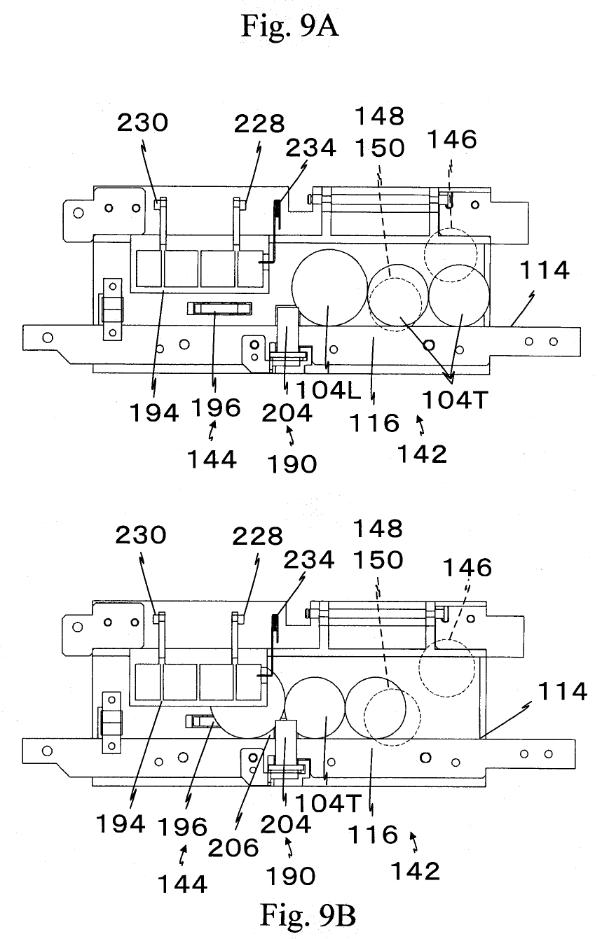

As shown in FIG. 9A, the support axes 228 and 230 are positioned on the extension of the movable side surface 222 (FIG. 5C) of the movable guide 194, and moreover, are disposed at a position as much far away from the rolling passage 122. As a result, when the movable guide 194 pivots counter-clockwise, an opening formed at the lateral side of the rolling passage 122 is not large. Consequently, there is the advantage that the token 104 rolling on the rolling passage 122 can be guided as many as possible. The movable guide 194 receives a biasing force clockwise by a predetermined force in FIG. 5C by biasing means 230. The biasing means 230 is a spring 234, which is wound around a columnar protrusion 232 protruding in the cross-sectional direction from the frame 210. This spring 234, when the token 104 drops from the rolling surface 114 by the canceler 196 and collides against a stopper 200 to be described later, preferably sets a spring force such that a sudden movement of the upper end portion of the contacted token 104 on the way to drop is damped. That is, by this buffering, it is possible to allow the token 104 to drop directly below. The token 104 dropped approximately directly below is piled up on the spot or returned to a return port through an opening formed at the dropping position. The biasing means 230 is replaceable by an actuator of a bob type, a pressure gas type, and the like in addition to the spring 234.

The canceler 196 has the functions of removing the token 104 rolled on the rolling passage 122 of the canceler device 144 from the rolling passage 122. In other words, the canceler 196 has the functions of dropping the token 104 rolled on the rolling surface 114 from the rolling surface 114. In the present embodiment, the canceler 196 is an L-shaped cancel lever 242, which is pivotally supported by a pivot axis 240 extending vertically against the rolling surface 114 in the lateral side of the rolling surface 114. The pivot axis 240 is fixed to a bearing (not shown) provided at the back surface of the fixed main body 192. The cancel lever 242 is formed directly above the rolling surface 114 of the fixed main body 192, and is movably disposed in parallel with the rolling surface 114 in a rectangular passage hole 246 extending in parallel with the rolling surface 114. The guide surface 248 of the cancel lever 242 heads from the upstream side of the rolling passage 122 to the downstream side, and moreover, extends in parallel with the rolling surface 114. Consequently, the cancel lever 242 is reciprocatable in the direction orthogonal to the rolling passage 122. The guide surface 248, when positioned at a waiting position, is flush-mounted with the side surface 210 of the fixed main body 192 or slightly receded into the passage hole 246.

When the cancel lever 242 is positioned at a cancel position, the guide surface 248 obliquely crosses the rolling passage 122. Consequently, the token 104 having rolled on the rolling passage 122 is guided in the direction to cross the rolling surface 114 by this guide surface 248, and therefore, it deviates from the rolling passage 122, and drops from the guide rail 116. The canceler 196 has a driven lever 250 extending in the direction vertical to the cancel lever 242, and the driven lever 250 is formed with a long hole 252.

The driving system 198 has the functions of moving the canceler 196 to a cancel position and moving the canceler 196 located at a cancel position to a standby position. The driving system 198 is fixed at the back surface of the fixed body 192. The driving system 198 includes an actuator 254, and a pin 258 of the top end of an output axis 256 of the actuator 254 is slidably inserted into the long hole 252. Consequently, when the pin 258 moves to the left in FIG. 5A, the cancel lever 242 pivots counter-clockwise, and the guide surface 248 protrudes into the rolling passage 122 and moves to the cancel position. When the pin 258 moves to the right while located at the cancel position, it moves to the position of FIG. 5A, and the guide surface 248 of the cancel lever 242 becomes flush with the side surface 210. The actuator 254 is an electromagnetic solenoid 260 in the present embodiment, and the output axis 256 is an iron core 262. Consequently, when the solenoid 260 is excited, the iron core is pulled out, and in FIG. 5A, it is moved to the left, and allows the cancel lever 242 to pivot counter-clockwise, and moves to the cancel position. When the solenoid 260 is demagnetized, the iron core 262 is moved to the right by a return spring 264 acting upon the iron core 262, and moves the cancel lever 242 to a stand by position.

The stopper 200 has the function of making a position of the token 104 which deviates from the rolling passage 122 and dropped and collided as a predetermined position. The stopper 200 is disposed downstream of the opening 212 and at the lateral side of the rolling passage 122, and is fixed to the frame 210. Consequently, the stopper 200 is better adapted to hard rubber having elasticity and abrasion resistance and the like in order to reduce a rebound of the token 104.

The passing sensor 266 includes a light emitting and receiving device 267 fixed to the fixed main body 192 and a prism 268 fixed to the frame 210. The light from the light emitting portion of the light emitting and receiving device 267 crosses over the rolling passage 122, and after that, is reflected by the prism 268 and recrosses over the rolling passage 122, and after that, enters the light receiving portion of the light emitting and receiving device 267. The crossing position of the emitted light is a position in the vicinity of the rolling surface 114, and is disposed at a position interrupted by all the tokens 104 passing through the selecting portion. When the light receiving portion of the light emitting and receiving device 267 is interrupted by the token 104 and does not receive the light, the passing sensor 266 outputs a token passing signal CS. The game machine performs a predetermined processing based on this token passing signal CS.

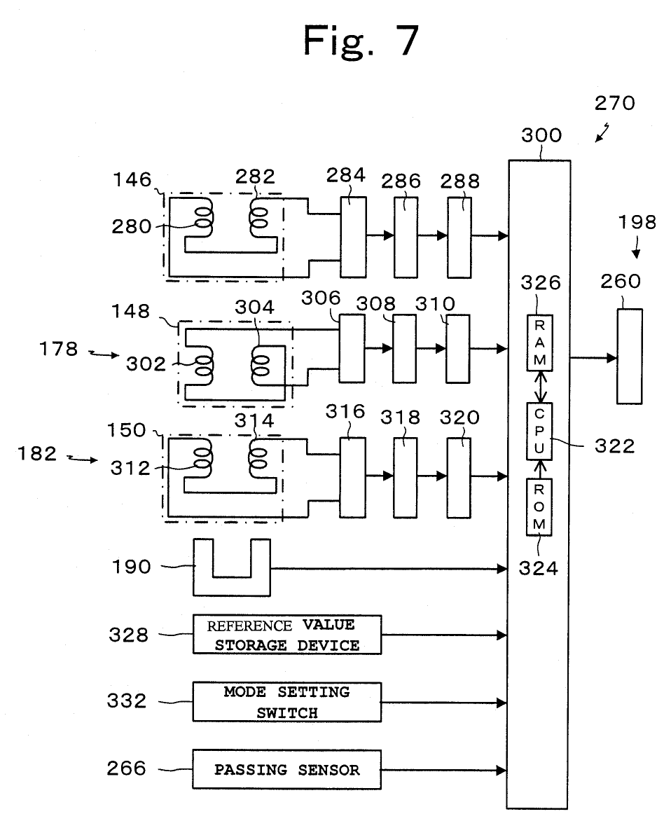

The control device 270 has the function of discriminating the authenticity of the input token 104 based on the detection signal from each sensor 146, 148, and 150, and operating the driving system 198 based on the timing signal from the timing sensor 190 when it is a false token, and removing the false token from the rolling passage 122 and dropping it from the guide rail 116. As shown in FIG. 7, the diameter sensor 146 has coils 280 and 282. These coils 280 and 282 are cumulatively connected, and are connected to an oscillation circuit 284. The oscillation circuit 284 is set to a low frequency, and is connected to a microprocessor 300 through a detection circuit 286 and an AD conversion circuit 288. The coil 178 of the thickness sensor 148 includes coils 302 and 304, and these coils 302 and 304 are differentially connected, and are connected to an oscillation circuit 306. The oscillation circuit 306 is connected to the microprocessor 300 through a detection circuit 308 and an AD conversion circuit 310. The oscillation frequency of the oscillation circuit 31 is set to a high frequency. The coil 182 of the material sensor 150 includes coils 312 and 314. These coils 312 and 314 are cumulatively connected, and are connected to an oscillation circuit 316. The oscillation circuit 316 is connected to the microprocessor 300 through a detection circuit 318 and an AD conversion circuit 320. The oscillation circuit 316 is set to a low frequency.

The microprocessor 300 includes a CPU 322, a ROM 324 and a RAM 326. In the microprocessor 300, the CPU 322 communicates with the RAM 326 based on a program stored in the ROM 324, and performs the discrimination of the authenticity of the token 104 compared with the data of a reference value setting device 328, and in the case of a false token, excites the solenoid 260 for a predetermined time. This excitation is performed for a short time so that it can be cancelled also when the token 104 continues to roll on. However, when the false token continues to roll on, the excitation can be continuously performed.

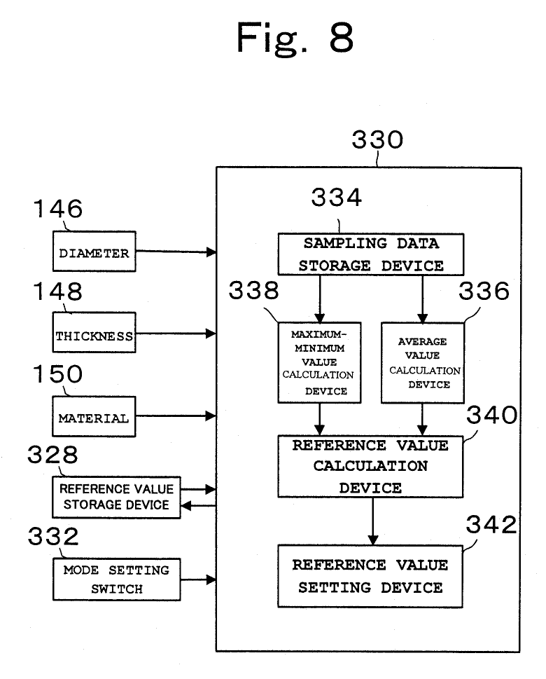

In the present embodiment, though the reference value setting device 330 is configured by software in the microprocessor 300, for the convenience of explanation, a description will be made by referring to the block diagram shown in FIG. 8. The reference value setting device 330 includes a mode setting switch 332 which is the selection reference value obtaining mode setting means, a sampling data storing device 334 which is the storage means, an average value calculation device 336, a maximum-minimum value calculation device 338, a reference value calculation device 340 which is calculating means, and a reference value setting device 342.

The mode setting switch 332 is a switch that switches a reference value setting mode to a selection mode. Consequently, in the case of the selection mode, as described above, the authenticity of the token 104 is discriminated based on the detection data of each sensor 146, 148, and 150, and in the case of the false token 104, it is cancelled by the canceler 196. In the case of the reference value setting mode, the detection data from each sensor 146, 148, 150 of the predetermined number of pieces of the tokens is sampled and stored, and when the predetermined number of pieces of the tokens 104 is input, based on the average value and the maximum-minimum value of these data, the predetermined reference value is calculated, and after that, it is stored in the reference value storage device 326 by the reference value setting device 342.

The sampling data storage device 334 has the function of storing the sampling data obtained by the diameter sensor 146, the thickness sensor 148 and the material sensor 150 for every input of the token 104 in the reference value setting mode. The average value calculation device 336 has the function of calculating the average value regarding the diameter, thickness, and material based on the sampling data stored in the sampling data storage device 334 when the predetermined number of pieces of the token 140 is input.

The maximum-minimum calculation device 338 has the function of calculating the maximum value and the minimum value of the diameter, thickness, and material, respectively, based on the sampling data stored in the storage device 336 when the same predetermined number of pieces of the token as the average value calculation device 336 is input.

The reference value calculation device 340 has the function of performing a predetermined processing based on the calculation results of the average value calculation device 336 and the maximum and minimum calculation device 338 and calculating a reference value. The reference value calculated by the reference value calculation device 340 is newly stored in the reference value storage circuit 328 by the reference value setting device 342.

After the new reference value is prepared, the mode setting switch 332 is switched over to the selection mode and the game machine is put into a playable state.

Similarly to the present embodiment, in case the reference value is set by the average value and the maximum-minimum value, if the true token deviated from the average value has a predetermined relationship with the maximum value and the minimum value, the token is not cancelled, but is accepted. That is, in the case of the average value only, the true token 104 deviated from the average value is cancelled, and the game can be performed. However, when the maximum value and the minimum value are added so as to set a reference value, even if the token deviates from the average value, when it has a predetermined relationship with the maximum-minimum values, there is the advantage that the token is discriminated as a true token and the game machine can be operated without causing any problems for the customer.

FIGS. 9A and 9B represent an example in which a large diameter false token 104L is input first, and then, two pieces of the true token 104T are input continuously. The token 104 rolls on the rolling surface 114, and after having passed through the sensor device 142, reaches the canceling device 144. In the sensor device 142, first, the token 104 is in opposed relationship to the diameter sensor 146 as shown in FIG. 9, and then, in opposed relationship to the thickness sensor 148 and the material sensor 150.

When the large diameter token 104L, which is the false token, is in opposed relationship to the diameter sensor 146, the magnetic field of the diameter sensor 146 is affected in proportion to the relative area, and the output voltage of the detection circuit 286 is sharply reduced as shown in DL in FIG. 10. This analogue signal is converted into a digital signal by the AD conversion circuit 288, and is transmitted to the microprocessor 300. In the case of the true token 104T, since the relative area of the diameter sensor 146 is smaller than the large diameter token 104L, the output voltage of the detection circuit 286 is reduced slightly. This analogue signal is transmitted to the microprocessor 300 similarly as described above.

Next, the magnetic fields of the thickness sensor 148 and the material sensor 150 are affected by the token 104. First, with reference to the thickness sensor 148, since its entire surface is in opposed relationship to the token 104, the output of the detection circuit 308 is reduced in the shape of the bottom of a pan pot as shown by a line T. This output is converted into a digital signal by the AD conversion circuit 310, and is transmitted to the microprocessor 300.

Next, with reference to the material sensor 150, since its entire surface is in opposed relationship to the token 104, the output of the detection circuit 318 is changed in the shape of a parabola as shown by a line M. This output is converted into a digital signal by the AD conversion circuit 320, and is transmitted to the microprocessor 300.

Next, the discrimination of the authenticity of the token 104 in the microprocessor 300 will be described. First, in a first step, the output (line D) of the diameter sensor 146 is compared with the reference value of the reference value storage device 326. When the output of the diameter sensor 146 is within the reference value, the processing proceeds to a second step, and when the output is outside the reference value, a cancel signal is output. In the case of FIGS. 9A and 9B, since the token is the false token 104L, it is discriminated as the outside of the reference value, and the cancel signal is output.

In the second step, the output (line T) of the thickness sensor 148 is compared with the reference value, and when it is outside the reference value, the cancel signal is output, and when it is within the reference value, the processing proceeds to a third step. In the third step, the output (line M) of the material sensor 150 is compared with the reference value, and when it is outside the reference value, the cancel signal is output, and when it is within the reference value, it is discriminated as the true token for the first time. In the case of the true token, the driving system 198 of the canceling device 196 is not operated. In other words, the solenoid 260 is not excited. Further, since the true token shuts down the optical axis of the passing sensor 266, the passing signal CS is output.

As described above, when the cancel signal is output, as shown in FIG. 10B, the control device 270 excites the solenoid 260 for a predetermined time T2 after a predetermined time T1 from the fall of the token signal CTS from the timing sensor 190. As a result, before the false token 104L reaches the cancel lever 242, the cancel lever 242 protrudes into the rolling passage 122 or pushes the side surface of the token 104 rolling on the rolling surface 114. As a result, the false token 104L deviates from the rolling passage 122, and drops from the guide rail 116. The dropped false token 104L drops obliquely by inertia force, and collides against the stopper 200. At this time, the upper portion of the false token 104L is positioned at the rolling passage 122. In other words, the upper portion of the false token 104L is guided by the movable side surface 222 of the movable guide 194 and the side surface 210 of the fixed main body 192. In this state, even when the false token 104L performs an intricate movement by the counter-reaction of collision against the stopper 200, it is buffered by a pushing force by the spring 234 of the movable guide 194, and the intricate movement is restrained, and the token drops immediately below. Further, the true token 104T rolls on by continuously following the false token 104L, and when its return movement to the stand-by position of the cancel lever 242 is delayed, the upper end portion of the true token 104T is guided by the movable guide 194, and therefore, it is prevented from dropping. Consequently, there is the advantage that the true token 104T is not dropped by mistake.

The dropped false token 104L is either accumulated immediately below or returned to a return port by passing through the passage. When the true token 104T passes through the canceling device 144, the solenoid 260 is not excited, and therefore, the true token rolls on the rolling passage 122 and drops from the throw-out port 108.

When the token type used is changed, as described above, the mode setting switch 332 is set to the reference value setting mode and a predetermined number of pieces of new token is input, so that a new reference value is automatically prepared and stored in the reference value storage device 326. Incidentally, the clocking of the predetermined time T1 in the control device 270 can be started from the rise signal of the token signal CTS. Further, the predetermined times T1 and T2 are automatically selected and set from a storage table according to the token size.

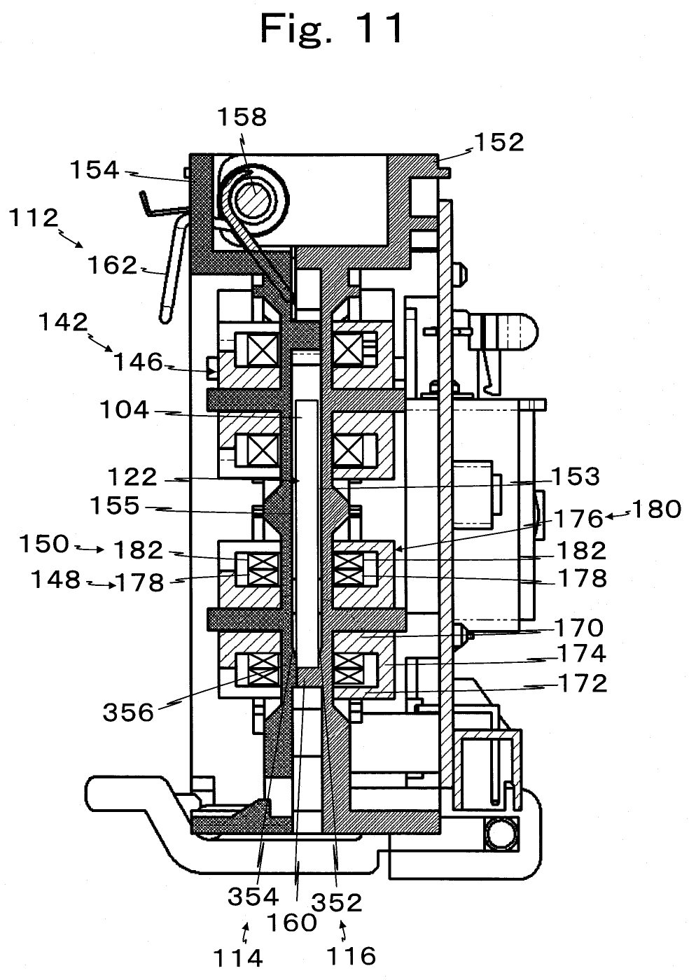

FIG. 11 is a cross-sectional view of a second embodiment which shows features equivalent to FIG. 2 (and FIGS. 5A-5C) of the first embodiment. The same reference numerals are attached to the same component parts as the first embodiment, and the description thereof is omitted, while a different configuration will be described.

The second embodiment is an example of a selecting device that can obtain characteristics regarding the token with a high degree of accuracy. In the second embodiment, a guide rail 116 is configured by a first inclined surface 352 protruding downward to a second main body 154 formed at the lower end portion of the first main body 152, and a second inclined surface 354 protruding upward to the first main body 152 formed at the lower end portion of the second main body 154. In other words, a rolling surface 114 of the token 104 is configured by the first inclined surface 352 and the second inclined surface 354. The first inclined surface 352 is an inclined surface that connects the side surface 153 of the first main body 152 and a space protrusion 160, and is inclined approximately at an angle of 60 degrees for the horizontal line. The second inclined surface 354 is an upper surface of the protrusion 356 that slightly protrudes to the lateral direction from the side surface 155 of the second main body 154, and is inclined approximately at an angle of 60 degrees for the horizontal line. Hence, the first inclined surface 352 and the second inclined surface 354 are symmetrically disposed by sandwiching a rolling passage 122. The width of the rolling passage 122 is defined by the side surface 153 of the first main body 152 and the side surface 155 of the second main body 154, and is set slightly larger than the thickness of the token 104 by striking the top end of the space protrusion 160 against the top end of the protrusion 356 of the second main body 154. In the second embodiment, a diameter sensor 146 is disposed on the same straight line vertical to the guide rail 116 away from guide rail 116 rather than a thickness sensor 148 and a material sensor 150. As a result, the thickness sensor 148, the material sensor 150 and the diameter sensor 146 are in opposed relationship to the token 140 approximately at the same location (same time position as to the rolling token), and therefore, the information on characteristics regarding the token can be obtained approximately at the same instance in time. Thus, the length of the sensor device 142 can be made short, and as a result, there is the advantage that a token input device can be made small.

The operation of the second embodiment will be described. In a selecting device 112, the token 104 has a left lower end peripheral surface rolled on a second inclined surface 354, and a right lower end peripheral surface rolled on a first inclined surface 352. As a result, the token 104 rolls on a position where reactive forces from the second inclined surface 354 and the first inclined surface 352 of the left and right are balanced. In other words, the token 104 passes the center of the rolling passage 122, specifically the center between the side surfaces 153 and 155. Even when the token is inclined and its upper end reclines to the side surfaces 153 or 154, while rolling on, the lower end of the token 104 is automatically positioned so that the reactive forces from the first inclined surface 352 and the second inclined surface 354 are balanced. In other words, the lower end of the token 104 is positioned at the center of the sensor units 180 of the left and right. Hence, in the thickness sensor 148 and the material sensor 150, the token 104 is positioned at the center of the pair of the left and right sensor units 180, and therefore, the magnetic fluxes generated from the left and right sensors are approximately equally operated, and this leads to the acquisition of highly accurate characteristic information on the token 104, and as a result, highly accurate authenticity discrimination can be performed. Particularly, since the thickness sensor, as described in the first embodiment, is differentially connected, it is easily affected by a distance between the token 104 and the sensor unit 180. However, in the present second embodiment, since the lower end portion of the token 104 rolls approximately on the center of the rolling passage 122 by the first inclined surface 352 and the second inclined surface 354, approximately equal information can be obtained from the left and right sensor units 180, and thus, there is the advantage that highly accurate discrimination can be performed in the microprocessor 300.

While specific embodiments of the invention have been shown and described in detail to illustrate the application of the principles of the invention, it will be understood that the invention may be embodied otherwise without departing from such principles.

What is claimed is:

1. A token input device of a game machine, the device comprising:
a token input port;
a rolling rail cooperating with the input port for allowing a token input from the token input port to roll on the rolling rail along a token path and drop on a predetermined position of the game machine; and
a selecting device disposed adjacent to the token path in the midst of the rolling rail, said selecting device including a token material sensor and a canceling device that removes the rolling token based on a signal from the material sensor, said canceling device being disposed downstream of said material sensor.

2. A token input device of the game machine according to claim 1, wherein the selecting device includes:
a diameter coil type magnetic sensor that obtains data regarding the diameter of a token on the rolling rail, said diameter coil type magnetic sensor being disposed facing the token path and located adjacent to said rolling rail;
a material coil type magnetic sensor that obtains data regarding the material and thickness of the token, said material coil type magnetic sensor being disposed facing the token path and located adjacent to said rolling rail and closer to the rolling rail than said diameter coil type magnetic sensor; and
a thickness coil type magnetic sensor that obtains data regarding the thickness of the token.

3. A token input device of the game machine according to claim 2, wherein said material coil type magnetic sensor and thickness coil type magnetic sensor each include:
central cylinders and include external walls at an outside of said central cylinders; and
ring shaped thickness coils disposed at the outside of the central cylinders of pot type cores the central cylinders and the external walls being connected by a bottom wall; and
ring type material coils disposed outside of said thickness coils.

4. A token input device of the game machine according to claim 1, wherein the canceling device includes a canceler pivotally attached to a pivot axis disposed in parallel with the token path at the lateral side of the token path, and the canceler has a free end positioned at the opposite side of the pivot axis reciprocated in the token path.

5. The token input device of the game machine according to claim 4, wherein said canceling device includes a movable guide that guides an upper end portion side surface of the rolling token at the opposite side of the canceler for the rolling rail.

6. The token selecting device in the token input device of the game machine according to claim 5, wherein the movable guide is elastically biased to the rolling passage.

7. The token selecting device in the token input device of the game machine according to claim 5, further comprising:
a control device that operates said canceling device; and
a token timing sensor disposed between the material sensor and the canceler device, wherein based on a false signal from the material sensor and the detection of the timing signal, said control device activating said canceling device.

8. A token selecting device in a token input device of a game machine provided with a token input allowing a token from an input port to roll on a rolling rail and drop on a predetermined position of a game machine, the selecting device comprising:
a token sensor device including a token material sensor in the midst of the rolling rail;
a canceling device that removes the rolling token based on a signal from the material sensor from the rolling rail;
a selection reference value obtaining mode setting means;
a storing means for storing a token signal from the token sensor device at the selection reference value obtaining mode time;
a calculating means for calculating the reference value based on the data stored in the storing means; and
a means for setting the reference value based on the calculation result of the calculating means.

9. A token input device of a game machine, the input device comprising:
an input port;
a rolling rail that allows a token input from an input port to roll on a rolling rail and drop on a predetermined position of the game machine;
a token selecting device in the midst of the rolling rail, said selecting device comprising a magnetic sensor including at least one of a token diameter sensor, a token material sensor or a token thickness sensor, said magnetic sensor comprising:
a central cylinder with an external wall at the outside of the central cylinder;
a pair of sensor units each with a ring shaped coil disposed at the outside of the central cylinder of a pot shaped core, by which bottom wall, the central cylinder and the external wall are connected;
a pair of sensor units attached opposite to a first main body and a second main body respectively, which are disposed at a predetermined interval by sandwiching the rolling rail in the selecting device, said rolling rail being configured by inclined planes protruding downward to mutually approach from the first main body and second main body; and
a canceling device to remove the rolling token based on the signal from the magnetic sensor from the rolling rail is disposed downstream of the magnetic sensor.
